(19) United States
(12) Patent Application Publication
(10) Pub. No.: US 2025/0240281 A1
(43) Pub. Date: Jul. 24, 2025

(54) Systems and Methods for Android Localhost Listener to Origin Bind Request to Stop Attacker-in-the-Middle (AITM) Attacks

(71) Applicant: Cisco Technology, Inc., San Jose, CA (US)

(72) Inventors: Robert Jacob Linial Small, Ann Arbor, MI (US); Dylan Miles Kite, Ann Arbor, MI (US); John D. Bruce, Ann Arbor, MI (US)

(21) Appl. No.: 18/582,143

(22) Filed: Feb. 20, 2024

Related U.S. Application Data
(60) Provisional application No. 63/622,174, filed on Jan. 18, 2024.

(51) Int. Cl. H04L 9/40; G06F 16/955

(52) U.S. Cl. CPC H04L 63/08; G06F 16/9566; H04L 2463/082

(57) ABSTRACT

In one embodiment, a method may receive an authorization request from a first device to access a resource. The method may validate, using a localhost listener, the authorization request by verifying an origin header of the authorization request based on a plurality of Uniform Resource Locators (URLs) in a trusted domain. In response to determining the authorization request is valid, the method may obtain a credential associated with the authorization request from a second device and validate proximity of the first device and the second device. In response to determining the first device is co-located with the second device, the method may approve the authorization request.

### RELATED APPLICATIONS

This application claims priority to U.S. Provisional Application No. 63/622,174, filed Jan. 18, 2024, which is hereby incorporated by reference in its entirety.

### TECHNICAL FIELD

The present disclosure relates generally to an apparatus and method for detecting and preventing attacker-in-the-middle (AITM) attacks against mobile authentications, and in particular, using a localhost listener inside a mobile application for origin binding on a request to open the mobile application.

### BACKGROUND

Electronic computing systems, such as mobile computing devices or servers, provide many useful and powerful services to improve business for companies and personal life for individuals. In recent years, electronic computing systems have implemented complex software components to effectively exchange data amongst a large number of nodes (e.g., clients, mobile computing devices, servers, etc.) within a network using various gateways (e.g., routers, etc.) and communications protocols. The software components are particularly susceptible to a cybersecurity attack associated with security breaches, data exfiltration, identity theft, fraud, and/or other types of unauthorized access to such communications. Thus, the number of phishing attacks associated with electronic computing systems also significantly increases. Traditional phishing attacks often duplicate/clone a website or attempt to drop malware to compromise and steal protected data and assets, such as personal or confidential information, associated with an account or service from a phished victim. In order to prevent a malicious entity from gaining access to the protected data and assets, cybersecurity infrastructure is critical for detecting, identifying, tracing, and analyzing each critical component or service that is incorporated into one or more high-risk components of the electronic computing devices. For example, electronic computing systems may use primary authentication or multi-factor authentication (MFA) to mitigate traditional phishing attacks by adding an extra layer of protection required to access the account or service. As another example, electronic computing systems may use a threat protection solution to mitigate cases where phishing drops malware to compromise the machine.

AITM attacks are a type of unauthorized access for a cyberattack where an attacker secretly relays and possibly alters the communications between two parties who believe that they are directly communicating with each other, as the attacker has inserted themselves between the two parties. For example, a node or other agent redirects or otherwise intercepts communications between two other nodes within the computing environment. Such AITM attacks can go unnoticed for long periods of time which, in turn, allows the attackers to obtain sensitive and damaging information such as payment credentials and the like. As another example, an AITM attacker sends a link to a phishing site to a true end user to steal sensitive credentials and bypass traditional security measures, such as the primary authentication or multiple-factor authentication, because the true end-user authenticates against a fake login page in the phishing site, instead of a valid site.

### BRIEF DESCRIPTION OF THE DRAWINGS

FIG. 1 illustrates an example network environment system associated with a client system for use in a product, in accordance with certain embodiments.

FIG. 2 illustrates an example AITM control system for preventing AITM attacks using inline authentication and localhost listener, in accordance with certain embodiments.

FIG. 3 illustrates an example signaling diagram for implementing an AITM attack against two-factor authentication, in accordance with certain embodiments.

FIG. 4 illustrates an example signaling diagram for preventing AITM attacks using mobile access device inline authentication and localhost listener, in accordance with certain embodiments.

FIG. 5 illustrates an example method for preventing AITM attacks using mobile access device inline authentication and localhost listener, in accordance with certain embodiments.

FIG. 6 illustrates an example computer access control system, in accordance with certain embodiments.

### DESCRIPTION OF EXAMPLE EMBODIMENTS

### Overview

In one or more embodiments, an apparatus may include one or more processors and one or more computer-readable non-transitory storage media comprising instructions that, when executed by the one or more processors, cause one or more components of the apparatus to perform operations. The operations include receiving an authorization request from a first device to access a resource. The operations further include validating, using a localhost listener, the authorization request by verifying an origin header of the authorization request based on a plurality of Uniform Resource Locators (URLs) in a trusted domain. In response to determining the authorization request is valid, the operations further include obtaining a credential associated with the authorization request from a second device and validating proximity of the first device and the second device. In response to determining the first device is co-located with the second device, the operations further include approving the authorization request.

In one or more embodiments, in response to determining the authorization request is invalid, the operations further include rejecting the authorization request and stopping the localhost listener. In response to determining the first device is not co-located with the second device, the operations further include rejecting the authorization request and stopping the localhost listener. In response to receiving the authorization request, the operations further include spinning up the localhost listener inside a mobile application of the first device. The localhost listener is a web server. The operations further include sending a GET request to the localhost listener to check an origin header on the authorization request using the plurality of URLs in the trusted domain. The operations further include comparing, using the localhost listener, the origin header of the authorization request to the plurality of URLs in the trusted domain. In response to determining the origin header of the authorization request matches the plurality of URLs in the trusted domain, the operations further include determining the authorization request is valid. In response to determining the origin header of the authorization request does not match the plurality of URLs in the trusted domain, the operations further include determining the authorization request is invalid and stopping the localhost listener. The operations further include performing a two-factor authentication approach to obtain the credential from the second device.

In one or more embodiments, a computer-implemented method, by an apparatus, may include receiving an authorization request from a first device to access a resource. The computer-implemented method further includes validating, using a localhost listener, the authorization request by verifying an origin header of the authorization request based on a plurality of Uniform Resource Locators (URLs) in a trusted domain. In response to determining the authorization request is valid, the computer-implemented method further includes obtaining a credential associated with the authorization request from a second device and validating proximity of the first device and the second device. In response to determining the first device is co-located with the second device, the computer-implemented method further includes approving the authorization request.

In one or more embodiments, in response to determining the authorization request is invalid, the computer-implemented method further includes rejecting the authorization request and stopping the localhost listener. In response to determining the first device is not co-located with the second device, the computer-implemented method further includes rejecting the authorization request and stopping the localhost listener. In response to receiving the authorization request, the computer-implemented method further includes spinning up the localhost listener inside a mobile application of the first device. The localhost listener is a web server. The computer-implemented method further includes sending a GET request to the localhost listener to check an origin header on the authorization request using the plurality of URLs in the trusted domain. The computer-implemented method further includes comparing, using the localhost listener, the origin header of the authorization request to the plurality of URLs in the trusted domain. In response to determining the origin header of the authorization request matches the plurality of URLs in the trusted domain, the computer-implemented method further includes determining the authorization request is valid. In response to determining the origin header of the authorization request does not match the plurality of URLs in the trusted domain, the computer-implemented method further includes determining the authorization request is invalid and stopping the localhost listener. The computer-implemented method further includes performing a two-factor authentication approach to obtain the credential from the second device.

In one or more embodiments, a non-transitory computer-readable medium may include instructions that are configured, when executed by a processor, to perform operations. The operations include receiving an authorization request from a first device to access a resource. The operations further include validating, using a localhost listener, the authorization request by verifying an origin header of the authorization request based on a plurality of Uniform Resource Locators (URLs) in a trusted domain. In response to determining the authorization request is valid, the operations further include obtaining a credential associated with the authorization request from a second device and validating proximity of the first device and the second device. In response to determining the first device is co-located with the second device, the operations further include approving the authorization request.

In one or more embodiments, in response to determining the authorization request is invalid, the operations further include rejecting the authorization request and stopping the localhost listener. In response to determining the first device is not co-located with the second device, the operations further include rejecting the authorization request and stopping the localhost listener. In response to receiving the authorization request, the operations further include spinning up the localhost listener inside a mobile application of the first device. The localhost listener is a web server. The operations further include sending a GET request to the localhost listener to check an origin header on the authorization request using the plurality of URLs in the trusted domain. The operations further include comparing, using the localhost listener, the origin header of the authorization request to the plurality of URLs in the trusted domain. In response to determining the origin header of the authorization request matches the plurality of URLs in the trusted domain, the operations further include determining the authorization request is valid. In response to determining the origin header of the authorization request does not match the plurality of URLs in the trusted domain, the operations further include determining the authorization request is invalid and stopping the localhost listener. The operations further include performing a two-factor authentication approach to obtain the credential from the second device.

Technical advantages of certain embodiments of this disclosure may include one or more of the following. Certain apparatuses and methods described herein may leverage the spinning up of a localhost listener inside a mobile application that will be pinged via a browser over the localhost to achieve origin binding on a request to open an application. In some embodiments, the localhost listener may be used to check an origin head of the request to verify the request is from a trusted domain. In some embodiments, the localhost listener may be used to check proximity by proving the request is from an access device which is co-located with or the same as the device which approves the authentication.

Other technical advantages will be readily apparent to one skilled in the art from the following figures, descriptions, and claims. Moreover, while specific advantages have been enumerated above, various embodiments may include all, some, or none of the enumerated advantages.

### EXAMPLE EMBODIMENTS

In certain embodiments, authentication is a key tool at the center of cybersecurity infrastructure against various cybersecurity attacks, such as phishing, associated with an electronic computing system. In particular, the electronic computing system may be a mobile device, a server, a personal computer, a laptop computer, a cellular telephone, a smartphone, a tablet computer, or an augmented/virtual reality device. For every new session, a user begins on a website to access a server, a user needs to use a web browser of an electronic computing system to undergo an authentication process which exchanges and validates a plurality of Secure Sockets Layer (SSL)/Transport Layer Security (TLS) certificates. SSL/TLS is a protocol or communication rule that allows two or more computer systems, such as the electronic computing system and the server, to talk to each other on the internet safely. SSL/TLS certification may act as digital identity cards which allow the electronic computing system to verify the identity and subsequently establish an encrypted network connection to the server using an SSL/TLS protocol. However, AITM phishing attacks work against primary authentication or MFA. For example, AITM attacks may be performed by a malicious actor in order to get an end user to authenticate against a phishing site, instead of the valid site. AITM attacks are usually associated with suboptimal implementations of SSL/TLS certificates. Thus, the malicious actor may alter an Internet Protocol (IP) address of a website, email address, or device and spoof the entity in order to make the end user think he/she is interacting with a trusted source when he/she is actually passing information to the malicious actor.

In certain embodiments, traditional authentication methods usually implement Web Authentication (WebAuthn) which is a proposed standard by World Wide Web Consortium's (W3C) to stop one or more AITM attacks. In particular, WebAuthn includes an application programming interface (API) which allows a mobile server to register and authenticate an end user using public key cryptography rather than a password. In particular, WebAuthn may be configured to generate a credential using a private-public key pair for a website. Thus, WebAuthn may be used to verify a website which the end user is logging into is the correct website. However, WebAuthn adoption is very low due to poor user experiences caused by inconsistent security settings for different websites. Therefore, an AITM control method without using WebAuthn is very useful to prevent AITM attacks against the electronic computing system.

In certain embodiments, a method for leveraging a localhost listener spun up inside of a mobile application of the electronic computing system for preventing AITM attacks against mobile authentications is provided. The method may include pinging a mobile application via a browser over the localhost listener to achieve origin binding on an authorization request to access a resource associated with a transaction. The method may include receiving the authorization request from an access device, such as a first mobile device. The method may include approving the authentication by a credential which may only be used to respond the authorization request from a trusted domain. The credential may be a user device, such as a second mobile device, approving the authentication for the transaction. The method may include verifying the authorization request is from a trusted domain. For example, the method may spin up a localhost listener inside of the mobile application. In particular, the method may apply the localhost listener to check an origin header associated with the authorization request using Origin Binding in order to make sure that the origin header matches a trusted uniform resource locator (URL).

In certain embodiments, the method may include verifying proximity of the access device which attempts to access the resource associated with the authorization request. In particular, the method may use the localhost listen to determine the access device is co-located with or is the same device as the credential approving the authentication. In response to determining that both the origin of the authorization request and the proximity of the access device are valid, the method may approve the authorization request. In other situations, the method may reject the authorization request.

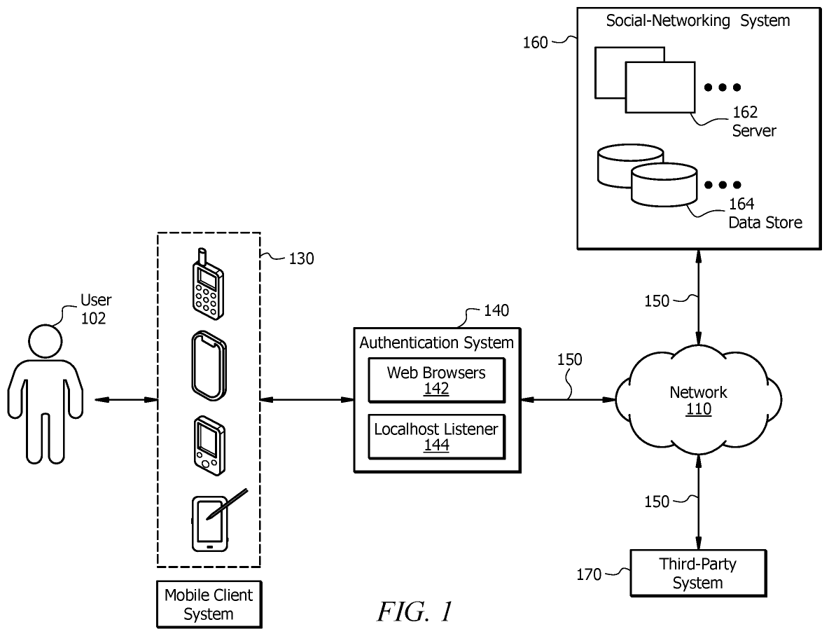

FIG. 1 illustrates an example network environment system 100 associated with a mobile client system 130 for use in a product, in accordance with certain embodiments. Network environment 100 includes a user 102, a mobile client system 130, an authentication system 140, a social-networking system 160, and a third-party system 170 connected to each other by a network 110. Although FIG. 1 illustrates a particular arrangement of user 102, mobile client system 130, authentication system 140, social-networking system 160, third-party system 170, and network 110, this disclosure contemplates any suitable arrangement of user 102, mobile client system 130, authentication system 140, social-networking system 160, third-party system 170, and network 110. As an example and not by way of limitation, two or more of user 102, mobile client system 130, authentication system 140, social-networking system 160, and third-party system 170 may be connected to each other directly, bypassing network 110. As another example, two or more of user 102, mobile client system 130, authentication system 140, social-networking system 160, and third-party system 170 may be physically or logically co-located with each other in whole or in part. Moreover, although FIG. 1 illustrates a particular number of mobile client systems 130, authentication systems 140, social-networking systems 160, third-party systems 170, and networks 110, this disclosure contemplates any suitable number of mobile client systems 130, authentication system 140, social-networking systems 160, third-party systems 170, and networks 110. As an example and not by way of limitation, network environment 100 may include multiple users 102, mobile client systems 130, authentication systems 140, social-networking systems 160, third-party systems 170, and networks 110.

In particular embodiments, user 102 may be an individual (human user), an entity (e.g., an enterprise, business, or third-party application), or a group (e.g., of individuals or entities) that interacts or communicates with or over social-networking system 160. In particular embodiments, social-networking system 160 may be a network-addressable computing system hosting an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. In particular embodiments, social-networking system 160 may include an authorization server (or other suitable component(s)) that allows users 102 to opt in to or opt out of having their actions logged by social-networking system 160 or shared with other systems (e.g., third-party systems 170), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users of social-networking system 160 through blocking, data hashing, anonymization, or other suitable techniques as appropriate. In particular embodiments, third-party system 170 may be a network-addressable computing system that can host aggregate data, in whole or in part, in a predetermined format or provide a service to user 102. Third-party system 170 may generate, store, receive, and send third-party system data, such as, for example, data in a file that is formatted to facilitate automated processing. Third-party system 170 may be accessed by the other components of network environment 100 either directly or via network 110. In particular embodiments, one or more users 102 may use one or more mobile client systems 130 and authentication systems 140 to access, send data to, and receive data from social-networking system 160 or third-party system 170. Mobile client system 130 may access social-networking system 160 or third-party system 170 directly, via network 110, or via a third-party system. As an example and not by way of limitation, mobile client system 130 may access third-party system 170 via social-networking system 160.

This disclosure contemplates any suitable network 110. Network 110 broadly represents any wireline or wireless network, using any of satellite or terrestrial network links, such as public or private cloud on the Internet, ad hoc networks, local area networks (LANs), metropolitan area networks (MANs), wireless LANs (WLANs), wide area networks (WANs), wireless WANs (WWANs), public switched telephone networks (PSTNs), campus networks, internetworks, cellular telephone networks, or combinations thereof. The network 110 may include or comprise the public internet and networked server computers that implement Web2 and/or Web3 technologies. Network 110 may comprise or support intranets, extranets, or virtual private networks (VPNs). Network 110 may also comprise a public switched telephone network (PSTN) using digital switches and call forwarding gear. Network 110 may also comprise a public switched telephone network (PSTN) using digital switches and call forwarding gear. Network 110 may include one or more networks 110.

Links 150 may connect mobile client system 130, authentication system 140, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, mobile client system 130 may be an electronic device including hardware, software, or embedded logic components or a combination of two or more such components and capable of carrying out the appropriate functionalities implemented or supported by mobile client system 130. In particular, mobile client system 130 may be any suitable computing device, such as, for example, a personal computer, a laptop computer, a cellular telephone, a smartphone, a tablet computer, or an augmented/virtual reality device. As an example and not by way of limitation, a mobile client system 130 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable mobile client systems 130. A mobile client system 130 may enable a network user at mobile client system 130 to access network 110. A mobile client system 130 may enable its user to communicate with other users at other client systems 130.

In particular embodiments, authentication system 140 may be an authentication component which is coupled between mobile client system 130 and network 110. Authentication system 140 may be configured to provide an interface between mobile client systems 130 with a self-signed certificate and a verifying computer in social networking system 160. As an example and not by way of limitation, for every new session user 102 begins on a website to access a server 162 in social network system 160, user 102 needs to use one or more web browsers 142 to undergo an authentication process which exchanges and validates a plurality of SSL/TLS certificates. In particular, authentication system 140 may be configured to perform one or more secure authentications, such as primary authentication, two-factor authentication, WebAuthn, etc., by using a localhost listener 144 to origin bind a request that opens an application out-of-the-box. Authentication system 140 may enable a credential at mobile client system 130 to respond to a request to access a website from a trusted domain. Authentication system 140 may enable a network user at mobile client system 130 to access the website by proving that the device accessing resources is co-located with or the same device as the credential approving the authentication.

In particular embodiments, authentication system 140 may include one or more web browsers 142, and may have one or more add-ons, plug-ins, or other extensions. A user at mobile client system 130 may enter a Uniform Resource Locator (URL) or other address directing the one or more web browsers 142 to a particular server (such as server 162, or a server associated with a third-party system 170), and the one or more web browsers 142 may generate a Hyper Text Transfer Protocol (HTTP) request and communicate the HTTP request to server. The server may accept the HTTP request and communicate to mobile client system 130 one or more Hyper Text Markup Language (HTML) files responsive to the HTTP request. Authentication system 140 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts, combinations of markup language and scripts, and the like. Herein, reference to a webpage encompasses one or more corresponding webpage files (which a browser may use to render the webpage) and vice versa, where appropriate.

In particular embodiments, social-networking system 160 may be a network-addressable computing system that can host an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. As an example and not by way of limitation, mobile client system 130 may access social-networking system 160 using one or more web browsers 142, or a native application associated with social-networking system 160 (e.g., a mobile social-networking application, a messaging application, another suitable application, or any combination thereof) either directly or via network 110. In particular embodiments, social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a mobile client system 130, an authentication system 140, a social-networking system 160, or a third-party system 170 to manage, retrieve, modify, add, or delete, the information stored in data store 164.

In particular embodiments, social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. Social-networking system 160 may provide users of the online social network the ability to communicate and interact with other users. In particular embodiments, users may join the online social network via social-networking system 160 and then add connections (e.g., relationships) to a number of other users of social-networking system 160 to whom they want to be connected. Herein, the term “friend” may refer to any other user of social-networking system 160 with whom a user has formed a connection, association, or relationship via social-networking system 160.

In particular embodiments, social-networking system 160 may provide users with the ability to take action on various types of items or objects, supported by social-networking system 160. As an example and not by way of limitation, the items and objects may include groups or social networks to which users of social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 160 or by an external system of third-party system 170, which is separate from social-networking system 160 and coupled to social-networking system 160 via a network 110.

In particular embodiments, social-networking system 160 may be capable of linking a variety of entities. As an example and not by way of limitation, social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating social-networking system 160. In particular embodiments, however, social-networking system 160 and third-party systems 170 may operate in conjunction with each other to provide social-networking services to users of social-networking system 160 or third-party systems 170. In this sense, social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a mobile client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 160 also includes user-generated content objects, which may enhance a user's interactions with social-networking system 160. User-generated content may include anything a user can add, upload, send, or “post” to social-networking system 160. As an example and not by way of limitation, a user communicates posts to social-networking system 160 from a mobile client system 130. Posts may include data such as status updates or other textual data, location information, photos, videos, links, music or other similar data or media. Content may also be added to social-networking system 160 by a third-party through a “communication channel,” such as a newsfeed or stream.

In particular embodiments, social-networking system 160 may include a variety of servers, sub-systems, programs, modules, logs, and data stores. In particular embodiments, social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 160 may also include suitable components such as network interfaces, security mechanisms, load balancers, failover servers, management-and-network-operations consoles, other suitable components, or any suitable combination thereof. In particular embodiments, social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 160 to one or more mobile client systems 130 or one or more third-party system 170 via network 110. The web server may include a mail server or other messaging functionality for receiving and routing messages between social-networking system 160 and one or more mobile client systems 130. An API-request server may allow a third-party system 170 to access information from social-networking system 160 by calling one or more APIs. An action logger may be used to receive communications from a web server about a user's actions on or off social-networking system 160. In conjunction with the action log, a third-party-content-object log may be maintained of user exposures to third-party-content objects. A notification controller may provide information regarding content objects to a mobile client system 130. Information may be pushed to a mobile client system 130 as notifications, or information may be pulled from mobile client system 130 responsive to a request received from mobile client system 130. Authorization servers may be used to enforce one or more privacy settings of the users of social-networking system 160. A privacy setting of a user determines how particular information associated with a user can be shared. The authorization server may allow users to opt in to or opt out of having their actions logged by social-networking system 160 or shared with other systems (e.g., third-party system 170), such as, for example, by setting appropriate privacy settings. Third-party-content-object stores may be used to store content objects received from third parties, such as a third-party system 170. Location stores may be used for storing location information received from mobile client systems 130 associated with users. Advertisement-pricing modules may combine social information, the current time, location information, or other suitable information to provide relevant advertisements, in the form of notifications, to a user.

Although FIG. 1 illustrates a particular number of users 102, networks 110, mobile client systems 130, authentication systems 140, web browsers 142, localhost listeners 144, links 150, social-networking systems 160, servers 162, data stores 164, and third-party systems 170, this disclosure contemplates any suitable number of users 102, networks 110, mobile client systems 130, authentication systems 140, web browsers 142, localhost listeners 144, links 150, social-networking systems 160, servers 162, data stores 164, and third-party systems 170. For example, user 102 may use one or more mobile client systems 130 to access resources from one or more servers 162.

Although FIG. 1 illustrates a particular arrangement of user 102, network 110, mobile client systems 130, authentication system 140, web browsers 142, localhost listener 144, link 150, social-networking system 160, server 162, data store 164, third-party system 170, this disclosure contemplates any suitable arrangement of user 102, network 110, mobile client systems 130, authentication system 140, web browsers 142, localhost listener 144, link 150, social-networking system 160, server 162, data store 164, third-party system 170.

Although FIG. 1 describes and illustrates particular components, devices, or systems carrying out particular actions, this disclosure contemplates any suitable combination of any suitable components, devices, or systems carrying out any suitable actions. For example, user 102 may use one or more mobile client systems 130 to access resources from one or more servers 162.

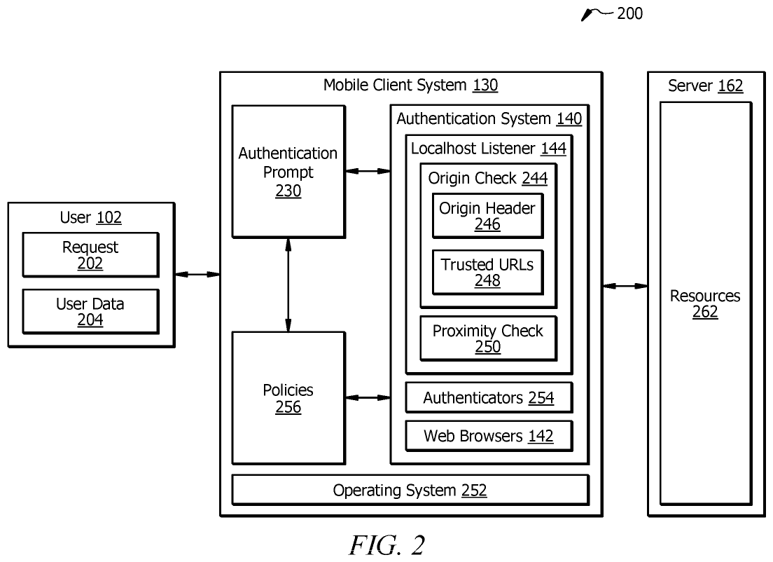

FIG. 2 illustrates an example AITM control system 200 for preventing AITM attacks using inline authentication and localhost listener, in accordance with certain embodiments. In some embodiments, AITM control system 200 may include user 102, mobile client device 130, and server 162. In some embodiments, mobile client device 130 may include a mobile application for mobile access device inline authentication, such authentication system 140 including a localhost listener 144. The mobile application may effectively prevent AITM attacks by using Origin Binding to prevent AITM attacks. For example, user 102 may use an access device, such as mobile client device 130, to send a request 202 to mobile client device 130 to access resources 262 from server 162. In some embodiments, user 102 may determine one or more web browsers 142 to generate an HTTP request which is subject to one or more policies 256 for resources 262 from server 162. In particular, user 102 may click to choose how to verify an authentication of user 102 by sending request 202 to an authentication prompt 230 associated with mobile client device 130. As another example, resources 262 may be information associated with financial transactions, protected data, and/or physical assets. In response to receiving request 202, mobile client device 130 may be programmed to spin up a localhost listener 144 in authentication system 140. Localhost listener 144 may be used to origin bind request 202 to determine a first verification indication by verifying origin of request 202 comes from a trusted domain.

In some embodiments, mobile client device 130 may be programmed to generate an information webpage associated with request 202 which is served to user 102 to collect a valid user credential to approve the authentication for request 202. In particular, an attacker may create a phishing campaign where the victim, such as user 102, successfully logs into a remote service but the attacker may intercept the victim's network and retrieve the user credential in an AITM attack. In order to prevent the AITM attack, localhost listener 144 may be used to determine a second verification indication by verifying that the access device is co-located or is the same device as the user credential or device approving the authentication. When both the first and second verification indications are received by mobile client device 130, resources 262 may be served to user 102 from a proxy server, such as server 162. Thus, AITM control system 200 may implement localhost listener 144 to provide that the request is coming from the same physical device which provides proof of proximity. Therefore, AITM control system 200 may effectively prevent AITM attacks by verifying that a device accessing resources is the same device as the device approving the authentication. Also, AITM control system 200 may be used to verify that request 202 is originated from a trusted domain, and not a fake domain. As a result, AITM control system 200 may collect data for user 102 and report improved telemetry for access devices by collecting the data from the mobile application.

In some embodiments, traditional authentication methods usually implement WebAuthn to stop the AITM attack. WebAuthn includes an API which allows a mobile server to register and authenticate a user using public key cryptography rather than a password. In particular, WebAuthn may be configured to generate a user credential using a private-public key pair for a website. For example, a private key is stored on a mobile device, such as mobile client device 130, of the user. As another example, a public key and randomly generated credential identification are stored on the mobile server. The mobile server may validate the identity of the user by using the public key. However, WebAuthn may not be easily adopted for all browsers because the WebAuthn protocol only supports certain platforms (e.g., Window 10 and Android), browsers (e.g., Microsoft Edge, Google Chrome, Mozilla Firefox, and Apple Safari), and authenticator transports (e.g., Universal Serial Bus (USB), Bluetooth Low Energy (BLE), and Near Field Communications (NFC)). Furthermore, traditional mobile operating systems may not provide a way to origin bind the authorization request, which opens an application out of the box.

In some embodiments, AITM control system 200 may be configured to use authentication prompt 230 of mobile client device 130 to choose an authentication method. Authentication prompt 230 may be a browser-based login to a web service or application, such an authentication prompt, of mobile client device 130. Thus, an end user, such as user 102, may use authentication prompt 230 of an access device, such as mobile client device 130, to generate an authorization request, such as request 202, to access resources 262 from server 162. Authentication prompt 230 may include one or more authentication methods (e.g., a Push method, a Phone Call method, or a Passcode method, etc.), which user 102 may choose how to verify his/her identity each time user 102 logs in. For example, when user 102 chooses the Push method in authentication prompt 230, a push notification or link may be sent to the access device to push a login request to user 102. User 102 may review the login request and tap Approval to log in. As another example, when user 102 chooses the Phone Call method in authentication prompt 230, a phone call may be called back to the access device associated with user 102 to approve the authentication. As another example, when user 102 chooses the Passcode method in authentication prompt 230, a passcode may be generated by a hardware token or provided by an administrator and texted to the access device via Short Message/Messaging Service (SMS). User 102 may log in by using the received passcode. In some embodiments, the access device may be configured to implement an operating system 252 to choose to block access to applications from an invalid device, such as a personal device or a public device, which is against policies 256. Thus, user 102 may complete authentication from a valid device to access resources 262 from server 162.

In some embodiments, AITM control system 200 may be configured to use authentication system 140 of mobile client device 130 to provide an improved authentication method by using Origin Binding to provide protections against AITM attacks without using WebAuthn. Authentication system 140 may implement a localhost listener 144, such as a web server, to determine if the authorization request from the access device associated with the end user is from a trusted domain. In response to receiving the authorization request, authentication prompt 230 may send a link to authentication system 140 for opening a mobile application together with a flag for starting a server, such as server 162. In response to receiving the flag, authentication system 140 may trigger an authentication process using one or more authenticators 254, such as two-factor authentication, on the server. As a result, the end user may receive a login request based on the authentication method which he/she choose in authentication prompt 230. The end user may use the access device to approve the authentication by providing a user credential, such as user data 204, during the authentication process. In particular, authentication system 140 may spin up localhost listener 144 inside a local web server of the mobile application. For example, authentication prompt 230 may ping localhost listener 144 at a predetermined frequency, such as every 1 second(s), on a specific port. In particular, authentication prompt 230 may send a GET request to localhost listener 144 to perform origin check 244 on the authentication request. For example, authentication system 140 may implement localhost listener 144 to check an origin header 246 associated with the authorization request on the local web server running inside the mobile application. Thus, authentication system 140 may determine if the origin header 246 matches a trusted URL 248 based on one or more policies 256. In response to determining the origin header 246 does not match the trusted URL 248, authentication system 140 may reject the authorization request.

In some embodiments, in response to determining origin header 246 matches the trusted URL 248, authentication system 140 may be configured to further perform proximity check 250 by verifying the proximity of the access device which attempts to access resources 262 associated with the authorization request. In particular, authentication system 140 may use localhost listener 144 to determine that the access device is co-located with or is the same user device approving the authentication. For example, authentication system 140 may use localhost listener 144 to determine that the authorization request comes from the same physical user device approving the authentication. In response to determining that the access device is the same user device approving the authentication, authentication system 140 may validate the authorization request for the end user. In response to determining that the access device is not the same user device approving the authentication, authentication system 140 may reject the authorization request. As a result, AITM control system 200 may use Origin Binding to verify that the authorization request comes from a trusted domain, and not a fake domain. Likewise, AITM control system 200 may use Origin Binding to validate the authorization request to prevent AITM attacks by verifying that the access device is the same device as the user device approving the authentication. This allows authentication system 140 to collect data from server 162 for the access device by fetching authentication transactions and reporting device telemetry associated with request 202. Thus, server 162 may send information associated with resources 262 to authentication system 140 to approve request 202 and send an authentication success to authentication prompt 230.

Although FIG. 2 illustrates a particular number of users 102, mobile client systems 130, authentication systems 140, web browsers 142, localhost listeners 144, servers 162, requests 202, user data 204, authentication prompts 230, origin checks 244, origin headers 246, trusted URLs 248, proximity checks 250, authenticators 254, operating systems 252, and policies 256, this disclosure contemplates any suitable number of users 102, mobile client systems 130, authentication systems 140, web browsers 142, localhost listeners 144, servers 162, requests 202, user data 204, authentication prompts 230, origin checks 244, origin headers 246, trusted URLs 248, proximity checks 250, authenticators 254, operating systems 252, and policies 256. For example, localhost listener 144 may perform Origin Binding for one or more requests 202 from user 102.

Although FIG. 2 illustrates a particular arrangement of user 102, mobile client systems 130, authentication system 140, web browsers 142, localhost listener 144, server 162, request 202, user data 204, authentication prompt 230, origin check 244, origin header 246, trusted URLs 248, proximity check 250, authenticators 254, operating systems 252, and policies 256, this disclosure contemplates any suitable arrangement of user 102, mobile client systems 130, authentication system 140, web browsers 142, localhost listener 144, server 162, request 202, user data 204, authentication prompt 230, origin check 244, origin header 246, trusted URLs 248, proximity check 250, authenticators 254, operating systems 252, and policies 256.

Although FIG. 2 describes and illustrates particular components, devices, or systems carrying out particular actions, this disclosure contemplates any suitable combination of any suitable components, devices, or systems carrying out any suitable actions. For example, localhost listener 144 may perform Origin Binding for one or more requests 202 from user 102.

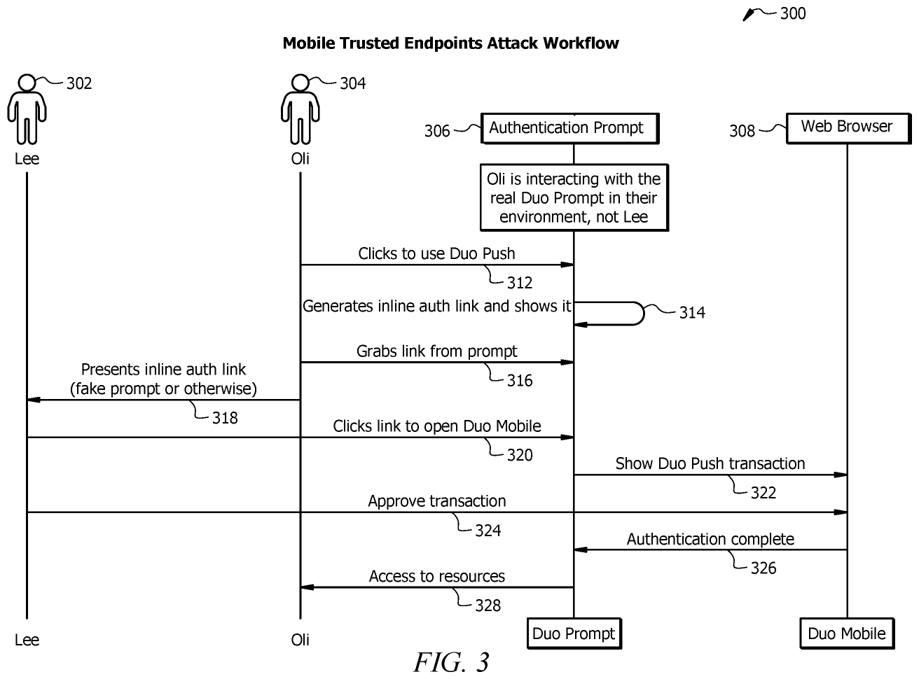

FIG. 3 illustrates an example signaling diagram 300 for implementing an AITM attack against two-factor authentication, in accordance with certain embodiments. Signaling diagram 300 includes a real user 302, an attacker 304, an authentication prompt 306, and a web browser 308. An AITM attack is an active form of eavesdropping in which attacker 304 independently interacts with the counterparties (e.g., real user 302) and authentication prompt 306, in a given transaction. Thus, a two-factor authentication process has difficulty in detecting and/or preventing the AITM attack because attacker 304 may use appropriate authentication, such as a primary authentication or two-factor authentication, to hijack an entire transaction, such as a financial transaction, to access one or more resources without breaking the cryptography of a user device to compromise its security. For example, attacker 304 may carry out a cyberattack against the two-factor authentication by secretly relaying and possibly modifying communications between two parties, such as real user 302 and authentication prompt 306. Because attacker 304 intercepts the communication between real user 302 and authentication prompt 230, attacker 304 may deliver a false message to one of the two parties under the guise of the other of the two parties. Thus, both parties may believe they are directly communicating with each other.

In some embodiments, attacker 304 may interact with authentication prompt 306 on a user device (e.g., an Android mobile device). For example, attacker 304 may click to send a signal 312 which includes an authorization request to authentication prompt 306 to access a resource associated with a transaction. Authentication prompt 306 may be connected with a web application for authentication, such as web browser 308, on the user device. In particular, web browser 308 may be implemented to verify the user's identity in a two-factor authentication process. Upon the receipt of the authorization request, authentication prompt 306 may be configured to generate a signal 314, which includes an inline authentication link and presents an inline authentication link to attacker 304. Thus, attacker 304 may grab an inline authentication link in a signal 316 from/to authentication prompt 306 and present the link in a signal 318 to real user 302. For example, attacker 304 may use a fake prompt or use other approaches to communicate the inline authentication link to end user 102. Attacker 304 may use the fake prompt to make end user 102 believe the faked prompt is secure and legitimate. As a result, real user 302 may click the inline authentication link in the fake prompt by sending a signal 320 to open web browser 308 to authenticate against a phishing site, instead of the valid site. For example, real user 302 may use the two-factor authentication to validate the authorization request which is initiated by attacker 304 by showing a signal 322 which includes a push transaction to web browser 308. Thus, real user 302 may send a signal 324 to approve the authentication request by providing a valid user credential for the identity of real user 302. Web browser 308 may verify the authorization request using the identity of real user 302 and send a signal 326 to authentication prompt 306 to indicate complete authentication. In response to receiving a complete authentication, authentication prompt 306 may send a signal 328 to attacker 304 to allow attacker 304 to access the resource associated with the authorization request. Real user 102, authentication prompt 306, and web browser 308 are unaware of the presence of attacker 304 and assume they are transacting securely with each other. The transaction and communications are intercepted and hijacked by attacker 304 performing an AITM attack.

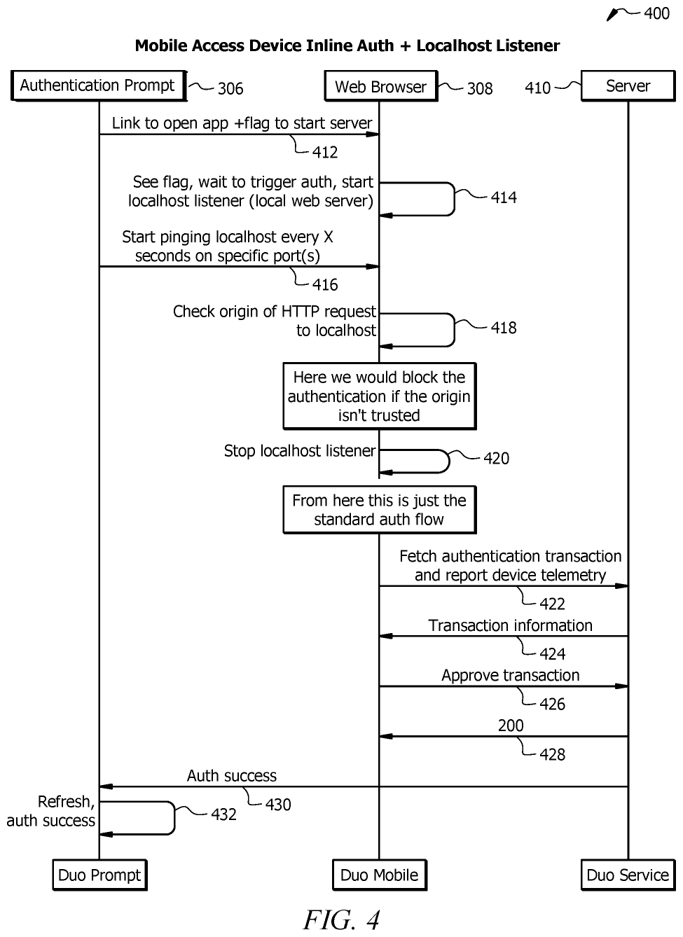

FIG. 4 illustrates an example signaling diagram 400 for preventing AITM attacks using mobile access device inline authentication and localhost listener, in accordance with certain embodiments. Signaling diagram 400 includes an authentication prompt 306, a web browser 308, and a server 410. In particular, server 410 may be a cloud service. Signaling diagram 400 may implement a two-step approach to stop AITM attacks by using Origin Binding: 1) verification of an authorization request from an access device which attempts to access a resource of a server by proving the authorization request is from a trusted domain; 2) verification of proximity of the access device which attempts to access the resource associated with the authorization request by proving that the access device is co-located with or is the same user device approving the authentication.

In some embodiments, an end user may use authentication prompt 306 associated with an access device to send an authorization request, such as an HTTP request, to web browser 308 to access a resource associated with a transaction. In some embodiments, authentication prompt 306 may send a signal 412 to an operating system to send a link to web browser 308 for opening a mobile application together with a flag for starting a server, such as server 410. In response to receiving the flag, web browser 308 may trigger an authentication process, such as two-factor authentication, on the server. The end user may use the access device to provide an authentication during the authentication process. In particular, web browser 308 may send a signal 414 to the operating system to spin up a localhost listener inside a local web server of the mobile application of web browser 308. Thus, authentication prompt 306 may generate a signal 416 to the operating system to ping the localhost listener at a predetermined frequency, such as every 2 seconds on a specific port. Upon the receipt of signal 416, web browser 308 may send a signal 418 to the operating system to send a GET request to the localhost listener to check an origin header associated with the authorization request on the local web server running inside the mobile application. Thus, web browser 308 may determine if the origin header of the authentication request matches a trusted URL based on one or more polices. In response to determining the origin header does not match the trusted URL, web browser 308 may send a signal 420 to the operating system to reject the authorization request and stop the localhost listener.

In some embodiments, in response to determining the origin header matches the trusted URL, web browser 308 may be configured to send a signal 422 to the operating system to further verify proximity of an access device which attempts to access the resource associated with the authorization request. Web browser 308 may perform a routine authentication flow based on a two-factor authentication to retrieve a credential associated with the authentication request from a user device. In particular, web browser 308 may use the localhost listener to determine that the access device is co-located with or is the same user device approving the authentication. For example, web browser 308 may use the localhost listener to determine that the authorization request comes from the same physical user device approving the authentication. In response to determining that the access device is the same user device approving the authentication, web browser 308 may validate the authorization request for the end user. Thus, web browser 308 may send a signal 422 to the operating system to collect data from server 410 for the access device by fetching authentication transactions and reporting device telemetry. Server 410 may send a signal 424 to the operating system to send transaction information web browser 308 to approve the transaction. In response to receiving the transaction information, web browser 308 may send a signal 426 to approve the transaction. As a result, server 410 may send a signal 428 to the operating system to complete the transaction and send a signal 430 to the operating system to send an authentication success to authentication prompt 306 to conclude the transaction by sending a signal 432 to the operating system after reporting authentication success to the end user.

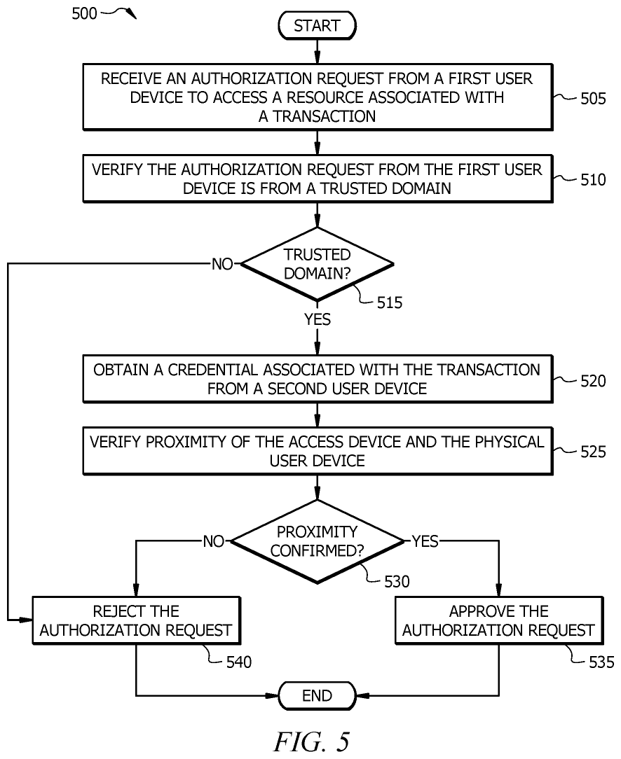

FIG. 5 illustrates an example method 500 for preventing AITM attacks using mobile access device inline authentication and localhost listener, in accordance with certain embodiments. Method 500 of FIG. 5 may be used by AITM control system 200 of FIG. 2. Method 500 starts at step 505, where AITM control system 200 (referring to FIG. 2) may receive an authorization request from a first user device, such as an access device, to access a resource associated with a transaction. For example, an end user may start a transaction on the first user device by prompting the user to send the authorization request to authentication system 140 (referring to FIG. 2) on the first user device. AITM control system 200 (referring to FIG. 2) may determine a credential for approving the authorization.

At step 510, AITM control system 200 (referring to FIG. 2) may verify the authorization request from the first user device is from a trusted domain. In particular, AITM control system 200 (referring to FIG. 2) may spin up a localhost listener, such as a web server, inside of a mobile application, such as authentication system 140 (referring to FIG. 2). AITM control system 200 (referring to FIG. 2) may send a GET request to the localhost listener to check the origin header associated with the authorization request using Origin Binding in order to make sure that the origin header matches a trusted URL.

At step 515, a determination is made whether the origin header matches the trusted URL. For example, AITM control system 200 (referring to FIG. 2) may determine a high possibility that the authorization requestion is valid when the origin header matches the trusted URL. Where the origin header does not match the trusted URL, the process may proceed to step 540. Where the origin header matches the trusted URL, the process may proceed to step 520.

At step 520, AITM control system 200 (referring to FIG. 2) may obtain a credential associated with the transaction from a second user device. For example, a two-factor authentication approach may be used to obtain the credential from the second user device.

At step 525, AITM control system 200 (referring to FIG. 2) may verify the proximity of the access device and the physical user device. The localhost listener used for the authorization request may provide high certainty that the authorization request comes from the same physical user device approving the authentication, which provides proof of proximity.

At step 530, a determination is made whether the authorization request comes from the same physical user device approving the authentication. Where the authorization request comes from the same physical user device approving the authentication, the process may proceed to step 535. Where the authorization request does not come from the same physical user device approving the authentication, the process may proceed to step 540. At step 535, AITM control system 200 (referring to FIG. 2) may approve the authorization request. At step 540, AITM control system 200 (referring to FIG. 2) may reject the authorization request.

Particular embodiments may repeat one or more steps of the method of FIG. 5, where appropriate. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates an example method to stop AITM attacks using inline authentication and localhost listener, including the particular steps of the method of FIG. 5, this disclosure contemplates any suitable method including any suitable steps, which may include all, some, or none of the steps of the method of FIG. 5, where appropriate. Furthermore, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

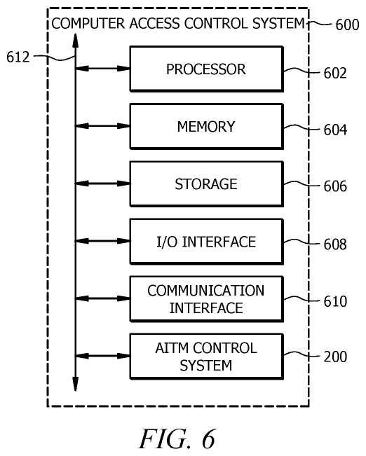

FIG. 6 illustrates an example computer access control system, in accordance with certain embodiments. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to an information handling system may encompass a computer or a computing device, and vice versa, where appropriate. Moreover, reference to an information handling system may encompass one or more computer systems, where appropriate. Further, the AITM control system in FIG. 2 may be incorporated into the illustrated computer system 600. With reference to the present disclosure, computer system 600 may be the aforementioned product incorporating AITM control system in FIG. 2, as described above with respect to FIG. 2. As such, “product” and “computer system 600” may herein be used interchangeably.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular information handling system having a particular number of particular components in a particular arrangement, this disclosure contemplates any suitable information handling system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network, a Long-Term Evolution (LTE) network, or a 5G network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific Ics (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

In an embodiment, computer system 600 may be configured to implement an AITM control process (see FIG. 2) in order to prevent AITM attacks using inline authentication and localhost listener. In an embodiment, computer system 600 may be configured to receive an authorization request from an access device to access a resource associated with a transaction. In an embodiment, computer system 600 may be configured to verify the authorization request from the access device is from a trusted domain. In an embodiment, computer system 600 may be configured to spin up a localhost listener inside of a mobile application. In an embodiment, computer system 600 may be configured to apply the localhost listener to check the origin header associated with the authorization request using Origin Binding in order to make sure that the origin header matches a trusted URL. In response to determining the origin header matches the trusted URL, computer system 600 may be configured to determine a high possibility that the authorization requestion is valid. In response to determining the origin header does not match the trusted URL, computer system 600 may be configured to reject the authorization request. In an embodiment, computer system 600 may be configured to verify proximity of the access device which attempts to access the resource associated with the authorization request. In an embodiment, computer system 600 may be configured to apply the localhost listener used for the authorization request to provide high certainty that the authorization request comes from the same physical user device approving the authentication. In response to determining the authorization request comes from the same physical user device approving the authentication, computer system 600 may be configured to approve the authorization request. In response to determining the authorization request does not come from the same physical user device approving the authentication, computer system 600 may be configured to reject the authorization request.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

The embodiments disclosed herein are only examples, and the scope of this disclosure is not limited to them. Particular embodiments may include all, some, or none of the components, elements, features, functions, operations, or steps of the embodiments disclosed herein. Embodiments disclosed herein include a method, an apparatus, a storage medium, a system and a computer program product, wherein any feature mentioned in one category, e.g., a method, can be applied in another category, e.g., a system, as well.

What is claimed is:

1. An apparatus, comprising:
one or more processors; and
one or more computer-readable non-transitory storage media comprising instructions that, when executed by the one or more processors, cause one or more components of the apparatus to perform operations comprising:
receiving an authorization request from a first device to access a resource;
validating, using a localhost listener, the authorization request by verifying an origin header of the authorization request based on a plurality of Uniform Resource Locators (URLs) in a trusted domain;
in response to determining the authorization request is valid, obtaining a credential associated with the authorization request from a second device;
validating proximity of the first device and the second device; and
in response to determining the first device is co-located with the second device, approving the authorization request.

2. The apparatus of claim 1, the operations further comprising:
in response to determining the authorization request is invalid, rejecting the authorization request and stopping the localhost listener.

3. The apparatus of claim 1, the operations further comprising:
in response to determining the first device is not co-located with the second device, rejecting the authorization request and stopping the localhost listener.

4. The apparatus of claim 1, the operations further comprising:
in response to receiving the authorization request, spinning up the localhost listener inside a mobile application of the first device, wherein the localhost listener is a web server.

5. The apparatus of claim 1, the operations further comprising:
sending a request to the localhost listener to check an origin header on the authorization request using the plurality of URLs in the trusted domain;
comparing, using the localhost listener, the origin header of the authorization request to the plurality of URLs in the trusted domain; and
in response to determining the origin header of the authorization request matches the plurality of URLs in the trusted domain, determining the authorization request is valid.

6. The apparatus of claim 5, the operations further comprising:
in response to determining the origin header of the authorization request does not match the plurality of URLs in the trusted domain, determining the authorization request is invalid and stopping the localhost listener.

7. The apparatus of claim 1, the operations further comprising:
performing a two-factor authentication approach to obtain the credential from the second device.

8. A computer-implemented method, comprising:
receiving an authorization request from a first device to access a resource;
validating, using a localhost listener, the authorization request by verifying an origin header of the authorization request based on a plurality of Uniform Resource Locators (URLs) in a trusted domain;
in response to determining the authorization request is valid, obtaining a credential associated with the authorization request from a second device;
validating proximity of the first device and the second device; and
in response to determining the first device is co-located with the second device, approving the authorization request.

9. The computer-implemented method of claim 8, further comprising:
in response to determining the authorization request is invalid, rejecting the authorization request and stopping the localhost listener.

10. The computer-implemented method of claim 8, further comprising:
in response to determining the first device is not co-located with the second device, rejecting the authorization request and stopping the localhost listener.

11. The computer-implemented method of claim 8, further comprising:
in response to receiving the authorization request, spinning up the localhost listener inside a mobile application of the first device, wherein the localhost listener is a web server.

12. The computer-implemented method of claim 8, further comprising:
sending a request to the localhost listener to check an origin header on the authorization request using the plurality of URLs in the trusted domain;
comparing, using the localhost listener, the origin header of the authorization request to the plurality of URLs in the trusted domain; and
in response to determining the origin header of the authorization request matches the plurality of URLs in the trusted domain, determining the authorization request is valid.

13. The computer-implemented method of claim 12, further comprising:
in response to determining the origin header of the authorization request does not match the plurality of URLs in the trusted domain, determining the authorization request is invalid and stopping the localhost listener.

14. The computer-implemented method of claim 8, further comprising:
performing a two-factor authentication approach to obtain the credential from the second device.

15. A non-transitory computer-readable medium comprising instructions that are configured, when executed by a processor, to perform operations comprising:
receiving an authorization request from a first device to access a resource;
validating, using a localhost listener, the authorization request by verifying an origin header of the authorization request based on a plurality of Uniform Resource Locators (URLs) in a trusted domain;
in response to determining the authorization request is valid, obtaining a credential associated with the authorization request from a second device;
validating proximity of the first device and the second device; and
in response to determining the first device is co-located with the second device, approving the authorization request.

16. The non-transitory computer-readable medium of claim 15, wherein the instructions are further configured to perform operations further comprising:
in response to determining the authorization request is invalid, rejecting the authorization request and stopping the localhost listener.

17. The non-transitory computer-readable medium of claim 15, wherein the instructions are further configured to perform operations further comprising:
in response to determining the first device is not co-located with the second device, rejecting the authorization request and stopping the localhost listener.

18. The non-transitory computer-readable medium of claim 15, wherein the instructions are further configured to perform operations further comprising:
in response to receiving the authorization request, spinning up the localhost listener inside a mobile application of the first device, wherein the localhost listener is a web server.

19. The non-transitory computer-readable medium of claim 15, wherein the instructions are further configured to perform operations further comprising:
sending a request to the localhost listener to check an origin header on the authorization request using the plurality of URLs in the trusted domain;
comparing, using the localhost listener, the origin header of the authorization request to the plurality of URLs in the trusted domain; and
in response to determining the origin header of the authorization request matches the plurality of URLs in the trusted domain, determining the authorization request is valid.

20. The non-transitory computer-readable medium of claim 15, wherein the instructions are further configured to perform operations further comprising:
performing a two-factor authentication approach to obtain the credential from the second device.
